(19) United States
(12) Patent Application Publication
(10) Pub. No.: US 2012/0145937 A1
(43) Pub. Date: Jun. 14, 2012

(54) Rotary valve for sample handling in fluid analysis

(76) Inventors: Bruce A. Richman, Sunnyvale, CA (US); Nabil M. R. Saad, Menlo Park, CA (US)

(21) Appl. No.: 12/928,506

(22) Filed: Dec. 13, 2010

(51) Int. Cl. F16K 5/00

(52) U.S. Cl. 251/304

(57) ABSTRACT

Efficiency of fluid analysis can be improved by utilizing a rotary valve capable of sequentially coupling 3 or more buffer chambers to 3 or more tasks. Such a rotary valve can be provided using a rotor having connections that geometrically form parallel chords of a circle. During analysis, such a valve can provide for parallel processing of several tasks and buffers. For example, one buffer chamber can be connected to a cleaning/evacuation port, another buffer chamber can be connected to a sample input port, and a third buffer chamber can be connected to an analytical instrument. Stepping the valve through its various positions can simultaneously move each of the buffer chambers to the next step in an analysis process.

### FIELD OF THE INVENTION

This invention relates to rotary valves, especially in connection with fluid analysis.

### BACKGROUND

In gas analysis, it is often desirable that the gas to be analyzed be provided to the analyzer in a homogenous continuous flow for an extended time, so that the analyzer can collect a multitude of data, either to analyze multiple gas analytes, or to average the data for individual analytes, thus improving the statistical result. It is known that the precision of a measurement improves monotonically with the length of measurement time. In addition, many analyzers cannot accurately or precisely measure analytes if the concentration changes rapidly, as in a transient pulse.

Such continuous gas flows can be provided by a buffering arrangement, where the analyte is coupled to a buffer chamber for some time, and then the buffer chamber is coupled to an analytical instrument. However, such analysis can be undesirably lengthy, because time has to be allocated for both buffering and analysis. Furthermore, in situations where multiple samples are to be analyzed, time has to be allocated to flushing the buffer chamber with an inert gas after a measurement in order to prepare for the next sample.

It would be an advance in the art to provide more efficient buffered analysis of gases (and of other fluids).

### SUMMARY

Efficiency of fluid analysis can be improved by utilizing a rotary valve capable of sequentially coupling 3 or more buffer chambers to 3 or more tasks. Such a rotary valve can be provided using a rotor having connections that geometrically form parallel chords of a circle. During analysis, such a valve can provide for parallel processing of several tasks and buffers. For example, one buffer chamber can be connected to a cleaning/evacuation port, another buffer chamber can be connected to a sample input port, and a third buffer chamber can be connected to an analytical instrument. Stepping the valve through its various positions can simultaneously move each of the buffer chambers to the next step in an analysis process.

### BRIEF DESCRIPTION OF THE DRAWINGS

FIG. 1 shows a prior art rotary valve.

FIG. 2 shows a rotary valve according to an embodiment of the invention.

FIG. 3 shows an embodiment of the invention suitable for use in connection with fluid analysis.

FIG. 4 shows another embodiment of the invention suitable for use in connection with fluid analysis.

FIGS. 5a-c show an embodiment of the invention having a platter-type rotor.

FIGS. 6a-b show an embodiment of the invention having a cylinder-type rotor.

### DETAILED DESCRIPTION

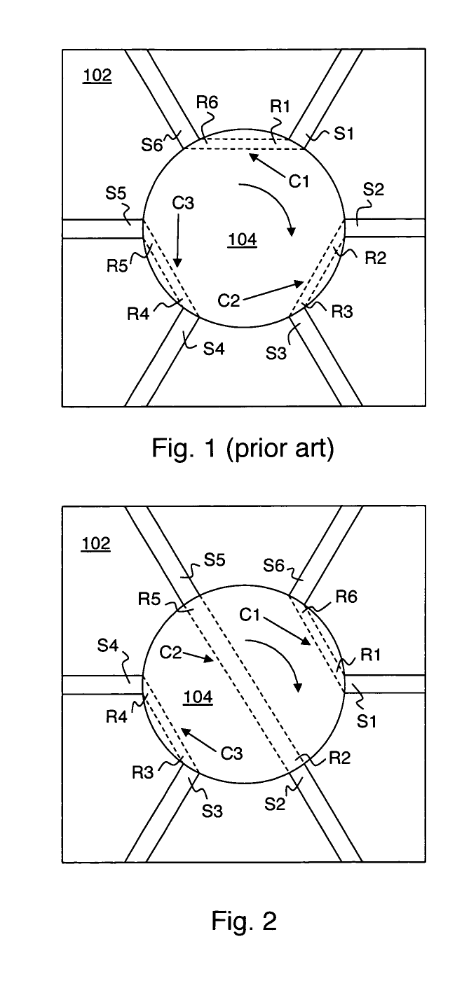

The present invention can be better appreciated by considering the prior art rotary valve of FIG. 1. In this example, a rotor 104 is capable of rotating with respect to a stator 102, as shown. Stator 102 has stator ports S1, S2, S3, S4, S5, and S6. Similarly, rotor 104 has rotor ports R1, R2, R3, R4, R5, and R6. Rotor 104 also includes several channels that define the connection between rotor ports, and thereby define the functions(s) performed by the valve. Here, channel C1 connects rotor ports R1 and R6, channel C2 connects rotor ports R2 and R3, and channel C3 connects rotor ports R4 and R5.

As is apparent from FIG. 1, this rotary valve always connects adjacent stator ports. In the configuration shown, stator ports S1 and S6 are connected, stator ports S2 and S3 are connected, and stator ports S4 and S5 are connected. If rotor 104 is rotated clockwise (or counterclockwise) by 60°, then stator ports S1 and S2 would be connected, stator ports S3 and S4 would be connected, and stator ports S5 and S6 would be connected. These two states are the only distinct states for this valve, so it can be referred to as a 2-state valve.

FIG. 2 shows a rotary valve according to an embodiment of the invention. This valve differs from the valve of FIG. 1 because channels C1, C2, and C3 connect different rotor ports on FIG. 2 than on FIG. 1. More specifically, channel C1 connects rotor ports R1 and R6, channel C2 connects rotor ports R2 and R5, and channel C3 connects rotor ports R3 and R4. As a result of this channel configuration, the valve of FIG. 2 is a 3-state valve as opposed to the 2-state valve of FIG. 1. The stator connections made by this valve are as follows:

| CW Rotation | Rotor state | Stator Connections | | |
|---|---|---|---|---|
| 0° | 1 | S1 [symbol] S6 | S3 [symbol] S4 | S5 [symbol] S2 |
| 60° | 2 | S1 [symbol] S2 | S3 [symbol] S6 | S5 [symbol] S4 |
| 120° | 3 | S1 [symbol] S4 | S3 [symbol] S2 | S5 [symbol] S6 |

The stator connections provided by this valve have several important properties. The first property is that every connection is between an odd stator port and an even stator port. Accordingly, it is convenient to refer to the odd and even stator ports as first and second sets of stator ports (or vice versa). At each position of the rotor, a one to one correspondence between the first and second sets of stator ports is provided, as is apparent from the table. Also, each of the 3 rotor positions provides a different correspondence between the first and second sets of stator ports. Although there are actually six rotor positions in the valve of this example, there are only three distinct states for the valve. For example, a 180° rotation of the rotor leads to the same state as shown on FIG. 2. Thus, “rotor position” as used herein refers to rotor positions that correspond to distinct states of the valve. A final property of significance is that the connections provided are “complete” in the following sense: any one of the odd stator ports can be connected to any one of the even stator ports by selecting the appropriate rotor state. Stator port S1 can be connected to any of stator ports S2, S4, and S6 by selecting the rotor state appropriately. This is also true for stator ports S3 and S5.

As will be seen below, this property of completeness is highly useful in fluid analysis applications. The conventional valve of FIG. 1 does not have this useful property. For example, stator port S1 on FIG. 1 cannot be connected to stator port S4. Similarly, stator ports S2 and S5 cannot be connected, and stator ports S3 and S6 cannot be connected.

The example of FIG. 2 relates to a valve having 6 ports. More generally, the rotor can have 2N rotor ports, where N is an integer greater than or equal to 3. The stator has a first set of N stator ports and a second set of N stator ports, where the first and second set of stator ports do not have any stator ports in common. The valve has N rotor positions with respect to the stator (i.e., there are N distinct valve states). Each of the N rotor positions makes connections between the stator ports such that a one to one correspondence between the first and second sets of stator ports is established. This one to one correspondence is distinct for each of the N rotor positions. Finally, any of the first set of stator ports can be connected to any of the second set of stator ports by selecting one of the N rotor positions.

In some embodiments, the stator ports have an alternating arrangement. More specifically, the stator ports can be numbered consecutively from 1 to 2N, and then the first and second sets of stator ports can be the odd and even numbered ports (or vice versa).

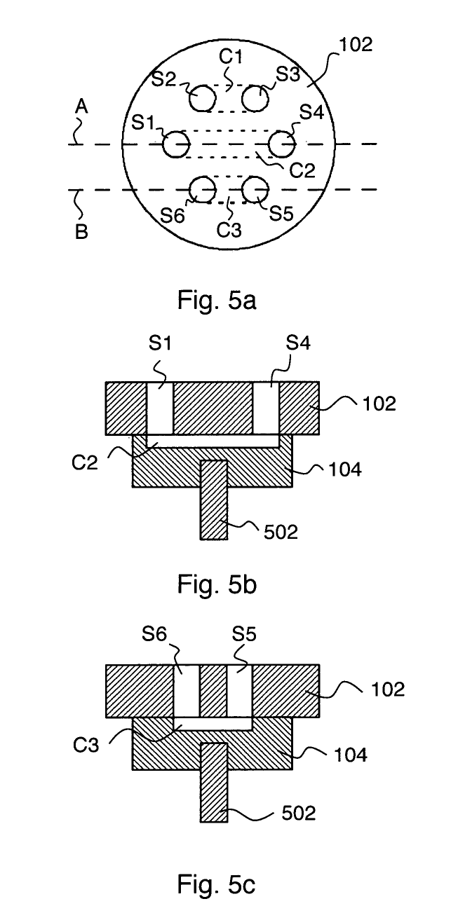

In some embodiments, the rotor ports are connected as follows. The rotor ports can be numbered consecutively (clockwise or counterclockwise) from 1 to 2N and indexed with an integer m (1≦m≦2N). With this numbering, rotor port m is connected to rotor port 2N+1−m for 1≦m≦2N. The example of FIG. 2 is consistent with this rotor connection scheme. Geometrically, this rotor connection pattern can be drawn as a set of parallel lines (chords on a circle) between the rotor ports. For odd N, one pair of opposite ports is connected, and for even N, no opposite pair is connected. The connections between ports do not intersect, and can therefore be fabricated by forming channels in the same plane, e.g., as in the platter-type rotor considered below in connection with FIGS. 5a-c.

With this connection scheme for the rotor, the possible connections of the stator ports are as follows. Let n be the rotor position, where 1≦n≦2N, and let m and m′ be sequentially numbered stator ports connected by the rotor, where 1≦m, m′≦2N. Then the relation between m and m′ is given by:

$${m}^{′} = 2 n + 1 - m + \{ \begin{matrix}- 2 N & 2 n \geq m + 2 N \\ 0 & m + 2 N > 2 n \geq m \\ 2 N & m > 2 n\end{matrix}$$

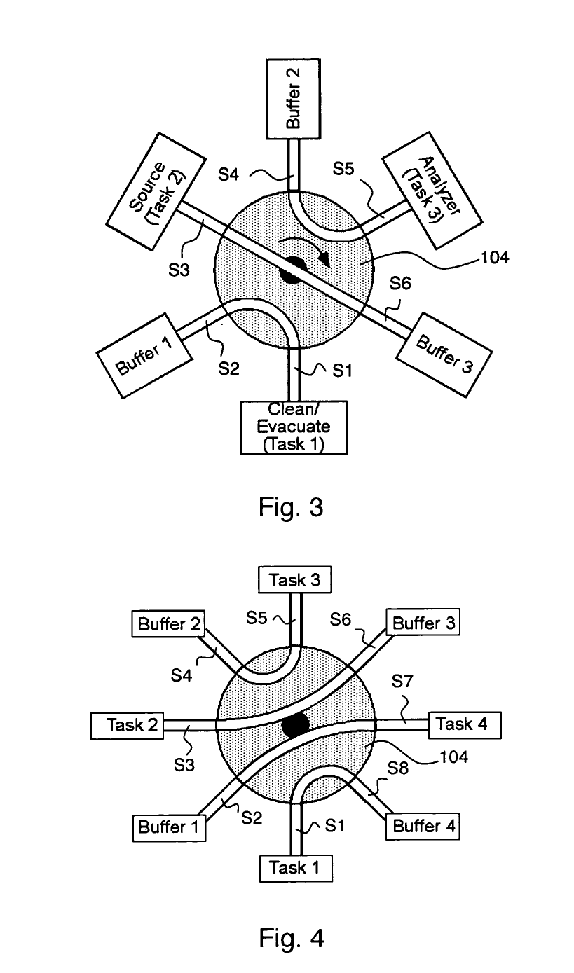

FIGS. 3 and 4 show embodiments of the invention suitable for use in connection with fluid analysis. In such applications, the stator ports of the valve are connected to task and buffer ports of a fluid analysis apparatus. More specifically, the tasks and buffers are connected to the first and second sets of stator ports (or vice versa). In the examples of FIGS. 3 and 4, the tasks are connected to the odd numbered stator ports, and the buffers are connected to the even numbered stator ports.

For the example of FIG. 3, the task and buffer connections are as follows, where T1, T2, and T3 are tasks, and S1, B2, and B3 are buffers.

| CW Rotation | Rotor state | Task/Buffer Connections | | |
|---|---|---|---|---|
| 0° | 1 | T1 [symbol] B1 | T3 [symbol] B2 | T2 [symbol] B3 |
| 60° | 2 | T2 [symbol] B1 | T1 [symbol] B2 | T3 [symbol] B3 |
| 120° | 3 | T3 [symbol] B1 | T2 [symbol] B2 | T1 [symbol] B3 |

From this table, we can see that the tasks are connected sequentially to the buffers. This property is highly advantageous for fluid analysis. Suppose that task 1 is cleaning/evacuating a buffer, task 2 is providing a sample to a buffer, and task 3 is performing analysis of sample in a buffer. From the table, it is apparent that tasks are performed in parallel in an efficient manner. Each buffer port sees a repeating sequence of clean/evacuate, admit sample, and analysis (in that order for clockwise rotor motion). Furthermore, when one buffer is being cleaned, another of the buffers is being analyzed, and the third is having a sample introduced to it. With a different assignment of tasks to ports, counter-clockwise rotation of the rotor could provide the same sequence of operations. In this example, analysis throughput can be improved by roughly a factor of 3 compared to a single buffer chamber system having evacuation/cleaning, sample introduction, and analysis tasks.

This kind of task sequencing can be provided for any number of tasks greater than or equal to 3. FIG. 4 shows an example with four tasks and buffers. Here the task and buffer connections are as follows:

| CW Rotation | Rotor state | Task/Buffer Connections | | | |
|---|---|---|---|---|---|
| 0° | 1 | T4 [symbol] B1 | T3 [symbol] B2 | T2 [symbol] B3 | T1 [symbol] B4 |
| 45° | 2 | T1 [symbol] B1 | T4 [symbol] B2 | T3 [symbol] B3 | T2 [symbol] B4 |
| 90° | 3 | T2 [symbol] B1 | T1 [symbol] B2 | T4 [symbol] B3 | T3 [symbol] B4 |
| 135° | 4 | T3 [symbol] B1 | T2 [symbol] B2 | T1 [symbol] B3 | T4 [symbol] B4 |

From this table, it is apparent that task sequencing as described above in connection with FIG. 3 is also present in this example.

This approach is suitable for analysis of any kind of fluid, including but not limited to: gases, liquids, particle suspensions, slurries, powdered solids, granular solids and combinations or mixtures thereof. Null tasks are allowed (e.g. a given task port may be left unattached or blanked off). An individual task may have sub-tasks within it. For example, a “cleaning/evacuation” task may involve a 3-way valve external to the rotary valve that switches between a zero gas purge and a vacuum pump. This 3-way valve can switch between the zero gas and pump several times within one rotary valve step interval, ending with the vacuum pump, thereby leaving the buffer evacuated.

In many cases, the rotor of a rotary valve has a generally cylindrical shape. In such cases, the rotor channels that provide the connections between the rotor ports can be disposed either on a flat surface of the rotor (i.e., an end face of the cylinder) or on a curved surface of the cylinder (i.e., the side wall of the cylinder). It is convenient to refer to rotors having channels on a flat rotor surface as platter-type rotors, and to refer to rotors having channels on a curved rotor surface as cylinder-type rotors. Both of these approaches are suitable for practicing the invention.

FIGS. 5a-c show an embodiment of the invention having a platter-type rotor. In this example, FIG. 5a is a top view showing stator 102, FIG. 5b is a cross section view along line A of FIG. 5a, and FIG. 5c is a cross section view along line B of FIG. 5a. Rotor 104 is affixed to an axle 502, and a fluid-tight seal is formed between stator 102 and rotor 104. Suitable methods for making such a fluid-tight seal are known in the art. The rotor channels are referenced as C1, C2, and C3. From this figure, it is apparent that this valve provides the same functionality as the valve in FIG. 2.

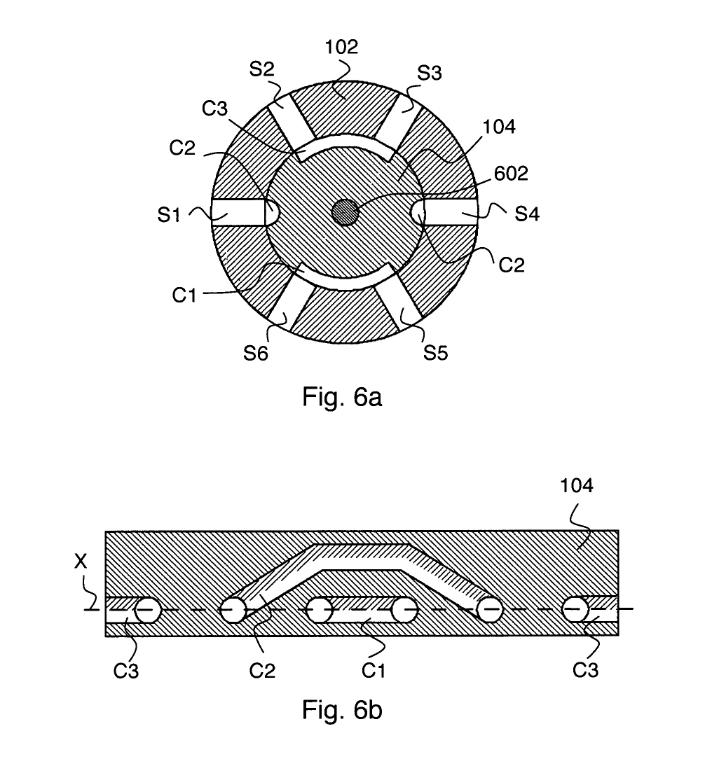

FIGS. 6a-b show an embodiment of the invention having a cylinder-type rotor. In this example, FIG. 6b is an outside side view of the circumference of rotor 104 (i.e., as it would be if unrolled to be flat), and FIG. 6a is a top cut-away view along line X of FIG. 6b. Rotor 104 is affixed to an axle 602, and a fluid-tight seal is formed between stator 102 and rotor 104. Suitable methods for making such a fluid-tight seal are known in the art. The rotor channels are referenced as C1, C2, and C3. From this figure, it is apparent that this valve also provides the same functionality as the valve in FIG. 2.

Practice of the invention does not depend critically on details of valve fabrication or valve materials.

1. A rotary valve comprising:
a rotor having 2N rotor ports, where N is an integer greater than or equal to 3;
a stator having a first set of N stator ports and a second set of N stator ports, wherein the first set and second set do not have any stator ports in common;
wherein the valve has N rotor positions with respect to the stator;
wherein each of the N rotor positions provides connections between the stator ports such that a one to one correspondence between the first set of stator ports and the second set of stator ports is made by the connections;
wherein the one to one correspondence is distinct for each of the N rotor positions; and
wherein any of the first set of stator ports can be connected to any of the second set of stator ports by selecting one of the N rotor positions.

2. The valve of claim 1, wherein the stator ports are numbered consecutively from 1 to 2N, wherein the first set of stator ports is the odd-numbered ports, and wherein the second set of stator ports is the even-numbered ports.

3. The valve of claim 1, wherein the rotor ports are numbered consecutively from 1 to 2N and indexed with an integer m, and wherein the rotor has channels that provide connections between rotor ports m and 2N+1−m for 1≦m≦2N.

4. The valve of claim 1, wherein the rotor ports are connected by channels on the rotor such that a pattern of the connections forms a set of parallel chords of a circle.

5. The valve of claim 1, wherein the rotor has a generally cylindrical shape, and wherein the rotor ports are formed by channels disposed on a flat surface of the rotor.

6. The valve of claim 1, wherein the rotor has a generally cylindrical shape, and wherein the rotor ports are formed by channels disposed on a curved surface of the rotor.

7. Apparatus for fluid analysis comprising the rotary valve of claim 1, wherein some or all of the first set of stator ports are connected to task ports of the fluid analysis apparatus, and wherein some or all of the second set of stator ports are connected to buffer ports of the fluid analysis apparatus.

8. The apparatus of claim 7, wherein multiple analysis tasks are simultaneously buffered by sequentially moving the rotor to its N positions.

9. The apparatus of claim 7, wherein the fluid is selected from the group consisting of gases, liquids, particle suspensions, slurries, powdered solids, granular solids and combinations or mixtures thereof.

10. The apparatus of claim 7, wherein the stator ports are numbered consecutively from 1 to 2N, wherein the first set of stator ports is the odd-numbered ports, and wherein the second set of stator ports is the even-numbered ports.
